(19) United States
(12) Patent Application Publication
(10) Pub. No.: US 2025/0016275 A1
(43) Pub. Date: Jan. 9, 2025

(54) IMAGE INSPECTION SYSTEM, INSPECTION AREA SETTING APPARATUS, AND RECORDING MEDIUM

(71) Applicant: Konica Minolta, Inc., Tokyo (JP)

(72) Inventor: Masaya IKUTA, Tokyo (JP)

(73) Assignee: Konica Minolta, Inc., Tokyo (JP)

(21) Appl. No.: 18/758,093

(22) Filed: Jun. 28, 2024

(30) Foreign Application Priority Data
Jul. 3, 2023 (JP) 2023-109235

(51) Int. Cl. H04N 1/00; G06T 7/00

(52) U.S. Cl. CPC H04N 1/00029; G06T 7/001; H04N 1/00013

(57) ABSTRACT

Disclosed is an image inspection system including a hardware processor that: acquires a read image obtained by reading an image on a sheet with an image reader; compares the acquired read image with a reference image to inspect whether there is an abnormality; sets a plurality of inspection areas with respect to the reference image; accepts designation of a first inspection area serving as a reference among the plurality of inspection areas by a first designation method; and accepts designation of a second inspection area, which is an inspection area other than the first inspection area among the plurality of inspection areas, by a second designation method different from the first designation method. The hardware processor sets the plurality of inspection areas based on the accepted designation of the first inspection area and the accepted designation of the second inspection area.

### BACKGROUND OF THE INVENTION

### Cross-Reference to Related Applications

This application claims priority to Japanese patent Application No. 2023-109235 filed on Jul. 3, 2023, the entire contents of which is incorporated herein by reference.

### TECHNICAL FIELD

The present invention relates to an image inspection system, an inspection area setting apparatus, and a recording medium.

### DESCRIPTION OF RELATED ART

Conventionally, an image forming apparatus that forms an image on a sheet is known. When the image forming apparatus forms an image, an original image may not be formed due to an unexpected factor or the like.

Therefore, an image inspection system has been disclosed in which an image read by an image reading device is compared with a reference image to determine whether the image is good or not (see, for example, Japanese Unexamined Patent Publication No. 2021-111873). The image reading device is arranged at a subsequent stage of the image forming apparatus. The reference image is a normal image serving as a reference.

Incidentally, variable printing is known in which only part of an image to be formed is replaced and printed. The above-described image inspection system can inspect an image formed (printed) in a variable area (inspection area) in which an image is replaced. Specifically, when a barcode or a number is printed in the variable area, the image inspection system inspects whether or not the barcode or the number is printed in a format intended by the user. For example, the image inspection system inspects whether a value intended by the user is included, whether numbers are arranged in an order intended by the user, and the like.

### SUMMARY OF THE INVENTION

Incidentally, when the image inspection system inspects a variable area, it is necessary to set where the variable area is on the reference image. However, the image inspection system has a problem in that setting is complicated when the number of variable areas is large. For example, in the example illustrated in FIG. 7, an area E31 in which numbers are printed and an area E32 in which a QR code (R) is printed are set as variable areas. Since there are nine areas E31 and nine areas E32, it is necessary to set the coordinates of a total of eighteen areas, which is complicated.

An object of the present invention is to provide an image inspection system, an inspection area setting apparatus, and a recording medium capable of reducing time and effort for setting an inspection area.

To achieve at least one of the abovementioned objects, according to an aspect of the present invention, image inspection system reflecting one aspect of the present invention is an image inspection system including a hardware processor that: acquires a read image obtained by reading an image on a sheet with an image reader; compares the acquired read image with a reference image to inspect whether there is an abnormality; sets a plurality of inspection areas with respect to the reference image; accepts designation of a first inspection area serving as a reference among the plurality of inspection areas by a first designation method; and accepts designation of a second inspection area, which is an inspection area other than the first inspection area among the plurality of inspection areas, by a second designation method different from the first designation method, wherein the hardware processor sets the plurality of inspection areas based on the accepted designation of the first inspection area and the accepted designation of the second inspection area.

To achieve at least one of the abovementioned objects, according to an aspect of the present invention, inspection area setting apparatus reflecting one aspect of the present invention is an inspection area setting apparatus including a hardware processor that: acquires a read image obtained by reading an image on a sheet with an image reader; compares the acquired read image with a reference image to inspect whether there is an abnormality; sets a plurality of inspection areas with respect to the reference image; accepts designation of a first inspection area serving as a reference among the plurality of inspection areas by a first designation method; and accepts designation of a second inspection area, which is an inspection area other than the first inspection area among the plurality of inspection areas, by a second designation method different from the first designation method, wherein the hardware processor sets the plurality of inspection areas based on the accepted designation of the first inspection area and the accepted designation of the second inspection area.

To achieve at least one of the abovementioned objects, according to an aspect of the present invention, a recording medium reflecting one aspect of the present invention is a non-transitory computer-readable recording medium storing a program for a computer of an image inspection system including a hardware processor that: acquires a read image obtained by reading an image on a sheet with an image reader; and compares the acquired read image with a reference image to inspect whether there is an abnormality, the program causing the computer to perform: setting a plurality of inspection areas with respect to the reference image; accepting designation of a first inspection area serving as a reference among the plurality of inspection areas by a first designation method; and accepting designation of a second inspection area, which is an inspection area other than the first inspection area among the plurality of inspection areas, by a second designation method different from the first designation method, wherein the computer sets the plurality of inspection areas based on the accepted designation of the first inspection area and the accepted designation of the second inspection area.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a diagram illustrating a schematic configuration of an image inspection system according to the present embodiment;

FIG. 2 is a functional block diagram illustrating a control structure of the image inspection system according to the present embodiment;

FIG. 3 is a diagram illustrating an example of a screen (inspection area setting screen) for setting a plurality of inspection areas in a reference image;

FIG. 4 is a diagram illustrating an example of an inspection area setting screen after a plurality of inspection areas are set;

FIG. 5 is a diagram showing an example of the inspection area setting screen on which a warning indicating that the setting of the number of repetitions is an error is displayed;

FIG. 6A is a diagram illustrating an example of the order in which images to be printed in a plurality of inspection areas designated by setting of a repetition condition are arranged;

FIG. 6B is a diagram illustrating an example of the order in which images to be printed in a plurality of inspection areas designated by setting of a repetition condition are arranged;

FIG. 6C is a diagram illustrating an example of the order in which images to be printed in a plurality of inspection areas designated by setting of a repetition condition are arranged;

FIG. 6D is a diagram illustrating an example of the order in which images to be printed in a plurality of inspection areas designated by setting of a repetition condition are arranged; and

FIG. 7 is a view illustrating an example of a conventional screen for setting a variable area.

### DETAILED DESCRIPTION

Hereinafter, one or more embodiments of the present invention will be described with reference to the drawings. However, the scope of the invention is not limited to the disclosed embodiments.

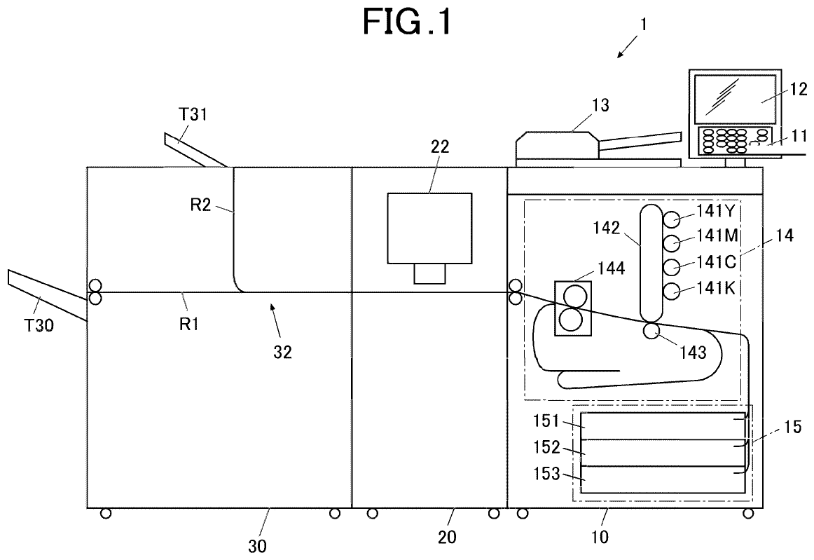

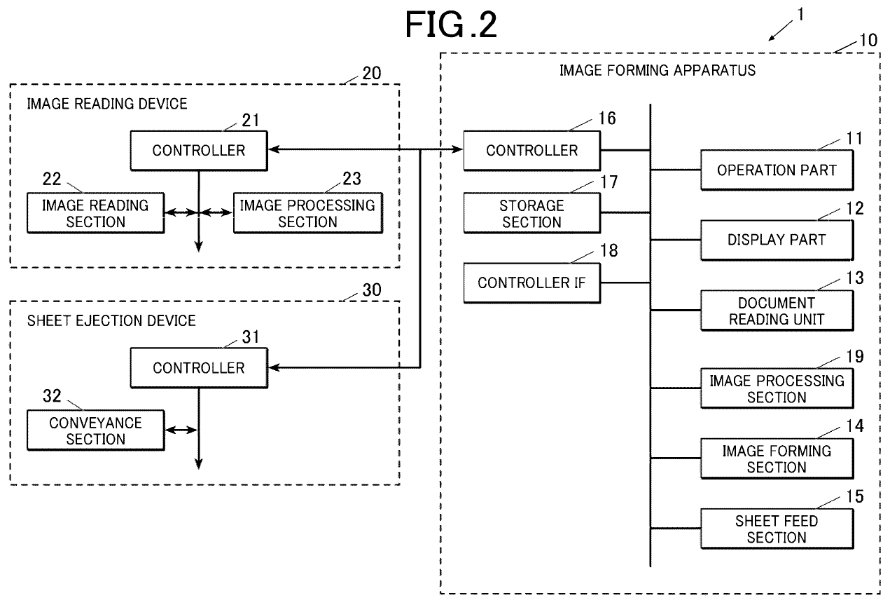

As shown in FIGS. 1 and 2, the image inspection system 1 according to the present embodiment includes an image forming apparatus 10, an image reading device 20, and a sheet ejection device 30.

The image forming apparatus 10 prints (forms) an image on a sheet based on image data included in a print job received from an external apparatus or the like. Alternatively, the image forming apparatus 10 prints an image on a sheet based on image data obtained by reading an image from a document. The sheet on which the image is printed is ejected to the image reading device 20.

As illustrated in FIGS. 1 and 2, the image forming apparatus 10 includes an operation part 11 (operation receiver), a display part 12 (display), a document reading unit 13, an image forming section 14, a sheet feed section 15, a controller 16 (hardware processor), a storage section 17, a controller IF18, and an image processing section 19.

The operation part 11 includes a touch panel formed so as to cover a display screen of the display part 12, and various operation buttons such as numeric buttons and a start button. The operation part 11 outputs an operation signal based on a user's operation to the controller 16.

The display part 12 is configured by a liquid crystal display (LCD). The display part 12 displays various screens according to an instruction of a display signal input from the controller 16.

The document reading unit 13 includes an automatic document feeder (ADF), a scanner, and the like. The document reading unit 13 outputs image data obtained by reading the image of the document to the controller 16.

The image forming section 14 forms an image on the sheet supplied from the sheet feed section 15 on the basis of the image data on which the image processing has been performed by the image processing section 19.

The image forming section 14 includes photosensitive drums 141Y, 141M, 141C, and 141K corresponding to the colors of yellow (Y), magenta (M), cyan (C), and black (K), an intermediate transfer belt 142, a secondary transfer roller 143, a fixing section 144, and the like.

The 141Y of the photosensitive drum is uniformly charged, and is then scanned and exposed to a laser beam based on the yellow image, so that an electrostatic latent image is formed. Next, the yellow toner is adhered to the electrostatic latent images on the 141Y of the photosensitive drum to develop the electrostatic latent images.

The photosensitive drums 141M, 141C, and 141K are the same as the photosensitive drum 141Y except for the colors to be treated, and therefore, description thereof is omitted.

The toner images in the respective colors formed on the photosensitive drums 141Y, 141M, 141C, and 141K are sequentially transferred onto the rotating intermediate transfer belt 142 (primary transfer). That is, a color toner image in which the toner images of four colors are superimposed is formed on the intermediate transfer belt 142.

The color toner images on the intermediate transfer belt 142 are collectively transferred onto a sheet by a secondary transfer roller 143 (secondary transfer).

The fixing section 144 includes a heating roller that heats the sheet on which the color toner image has been transferred, and a pressure roller that presses the sheet. The fixing section 144 fixes the color toner image to the sheet by heating and pressing.

The sheet feed section 15 includes sheet feeding trays 151, 152, and 153, and supplies sheets to the image forming section 14. Each of the sheet feed trays 151, 152, and 153 stores sheets of a paper type and a size determined in advance for each sheet feed tray.

The controller 16 includes a central processing unit (CPU), a read only memory (ROM), and a memory.

The CPU reads out various processing programs stored in the ROM and performs centralized control of operations of the respective units of the image forming apparatus 10 in accordance with the programs.

The ROM is composed of a nonvolatile semiconductor memory and the like, and stores various processing programs, parameters and files necessary for executing the programs, and the like.

The memory includes a dynamic random access memory (DRAM) and the like, and temporarily stores programs and various types of data such as image data related to various types of image processing.

For example, the controller 16 acquires a read image obtained by reading an image on a sheet with the image reading section 22. That is, the controller 16 functions as an acquisition section of the present invention.

In addition, the controller 16 compares the acquired read image with the reference image to inspect the presence or absence of abnormality. That is, the controller 16 functions as an image inspection section of the present invention.

The controller 16 controls the image reading device 20 via the controller 21. Further, the controller 16 controls the sheet ejection device 30 via the controller 31.

The storage section 17 is a nonvolatile storage device such as a hard disk drive (HDD) or a semiconductor memory that stores various types of data such as programs and image data. The storage section 17 stores data such as program data and various types of setting data in a readable and writable manner from the controller 16.

A controller interface (IF) 18 receives a print job transmitted from an external device or the like. The received print job is output to the controller 16.

The image processing section 19 performs necessary image processing on the image data, and transmits the image data after the image processing to the image forming section 14. The image processing includes, for example, tone processing, halftone processing, and color conversion processing. The gradation processing is processing for converting a gradation value of each pixel of the image data into a gradation value corrected so that a density characteristic of an image formed on a sheet matches a target. The halftone processing is error diffusion processing, screen processing using a systematic dither method, or the like. The color conversion processing is processing for converting each tone value of RGB into each tone value of CMYK.

The image reading device 20 is connected to a subsequent stage of the image forming apparatus 10. The image reading device 20 includes a controller 21, an image reading section 22 (image reader), and an image processing section 23.

The controller 21 includes a CPU, a ROM, and a RAM and comprehensively controls operation of sections of the image reading device 20.

The image reading section 22 includes, for example, a linear image sensor, an optical system, and a light source. The linear image sensor is, for example, a charge coupled device (CCD) line sensor or the like. The image reading section 22 reads the sheet on which the image has been formed by the image forming section 14 and outputs the obtained read image to the image processing section 23. The sheet read by the image reading section 22 is conveyed to the sheet ejection device 30.

The image processing section 23 performs various processing on analog image data input from the image reading section 22, and then generates RGB digital image data. The various kinds of processing are, for example, analog processing, Analogue-to-Digital (A/D) conversion processing, shading processing, and the like. The image data generated by the image processing section 23 is output to the controller 16 of the image forming apparatus 10.

The sheet ejection device 30 is connected to a subsequent stage of the image reading device 20, and includes a controller 31 and a conveyance section 32.

The controller 31 includes a CPU, a ROM, and a RAM, and comprehensively controls the operation of each part of the sheet ejection device 30.

The conveyance section 32 includes a plurality of roller pairs, and discharges the sheet conveyed from the image reading device 20 to the sheet ejection tray T30 or the purge tray T31. The conveyance section 32 includes a purge path R2 that branches from the conveying path R1 and connects to the purge tray T31. The conveyance path R1 leads to the sheet ejection tray T30. When there is no abnormality in the read image obtained by reading the sheet by the image reading section 22, the conveyance section 32 discharges the sheet to the sheet ejection tray T30. When there is an abnormality in the read image obtained by reading the sheet by the image reading section 22, the conveyance section 32 discharges (purges) the sheet to the purge tray T31.

In the present embodiment, the controller 16 of the image forming apparatus 10 sets a plurality of inspection areas in the reference image. That is, the controller 16 functions as a setter of the present invention. Each inspection area is a variable area, and a different image (a barcode, a number, or the like) is printed for each inspection area.

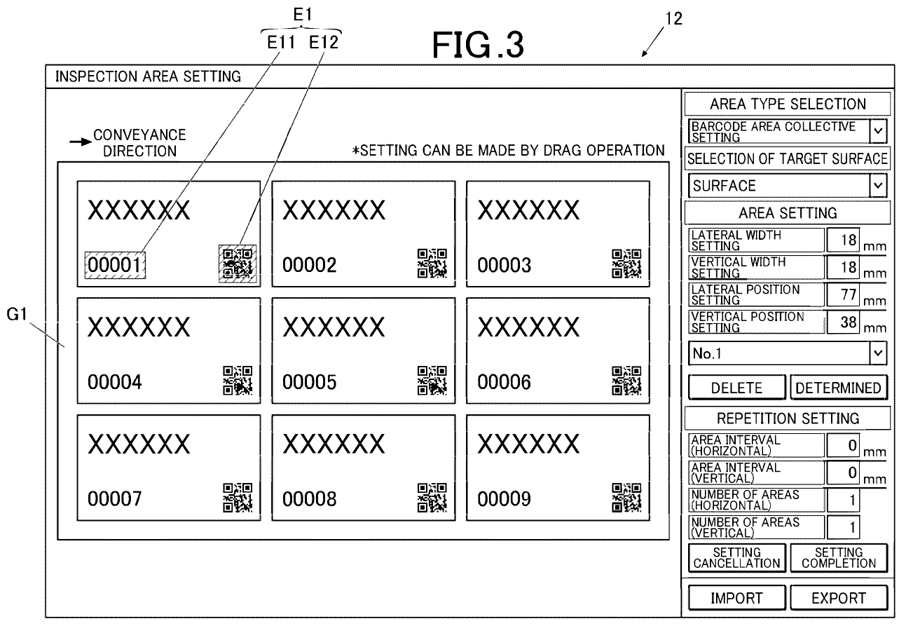

FIG. 3 shows an example of a screen (inspection area setting screen) for setting a plurality of inspection areas in the reference image G1. The user performs an operation for setting a plurality of inspection areas via the operation part 11 on the inspection area setting screen displayed on the display part 12.

Specifically, first, the controller 16 accepts, by a first designation method, designation of a first inspection area to be a reference among the plurality of inspection areas. That is, the controller 16 functions as a first acceptance section of the present invention. A first designation method includes, for example, a method of designating an image to be inspected with respect to the reference image, a method of surrounding a predetermined area in the reference image, and a method of designating the coordinates of a predetermined area in the reference image. The user designates a first inspection area by a first designation method via the operation part 11. The controller 16 accepts designation of a first inspection area by a first designation method.

For example, in the example illustrated in FIG. 3, the area E11 in which the number of the image on the upper left of the reference image G1 is printed and the area E12 in which the QR code is printed are set (designated) as the first inspection area E1.

Next, the controller 16 accepts designation of a second inspection area, which is an inspection area other than the first inspection area among the plurality of inspection areas, by a second designation method. That is, the controller 16 functions as a second acceptance section of the present invention. The second designation method is a method different from the first designation method, and is, for example, a method of setting repetition conditions for a plurality of inspection areas. The repetition condition is, for example, the interval between the inspection areas or the number of repetitions of the inspection area. The user designates the second inspection area by the second designation method via the operation part 11. The controller 16 accepts designation of a second inspection area by a second designation method.

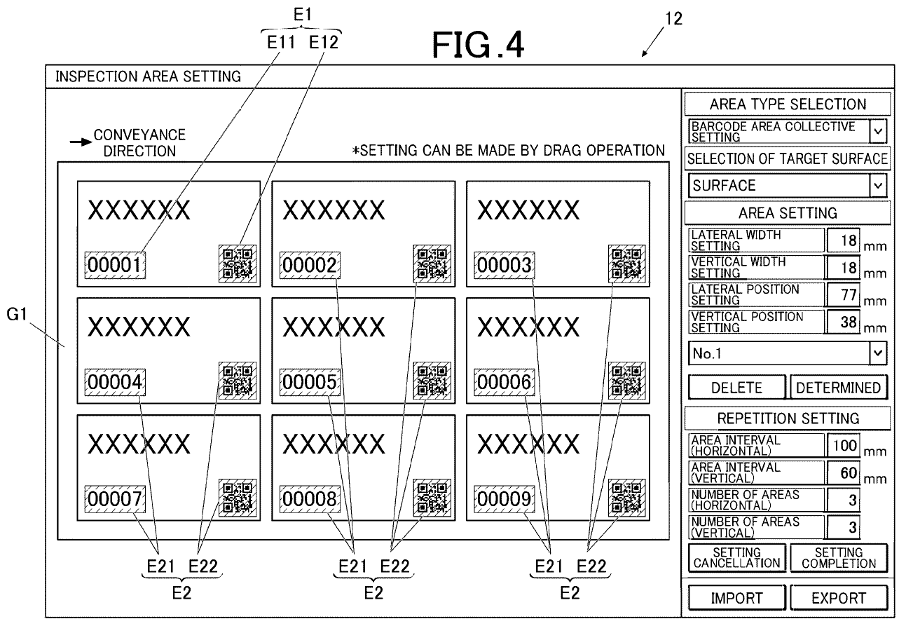

For example, in the example illustrated in FIG. 4, the intervals between the inspection areas are set to be 100 mm in the horizontal direction and 60 mm in the vertical direction. In addition, the number of repetitions of the inspection area is set to three. That is, in the example shown in FIG. 4, the first inspection area E1 (E11 and E12) is repeated three times in the horizontal direction and three times in the vertical direction, and a total of nine inspection areas are set. To be specific, eight inspection areas other than the first inspection area E1 are set as the second inspection areas E2 (E21 and E22). The symbol E21 represents an area of the second inspection area E2 where a number is printed. The reference sign E22 indicates an area of the second inspection area E2 where the QR code is printed.

As described above, the controller 16 sets a plurality of inspection areas based on the designation of the first inspection area and the designation of the second inspection area.

Further, the controller 16 controls the setting of the number of repetitions of the inspection area. That is, the controller 16 functions as a setting controller of the present invention.

Specifically, when the number of repetitions is set, the controller 16 performs predetermined control in a case where the value of the number of repetitions is large and the inspection area after the repetition exceeds the range of the reference image. The inspection area after repetition is an inspection area after repetition for a set number of repetitions.

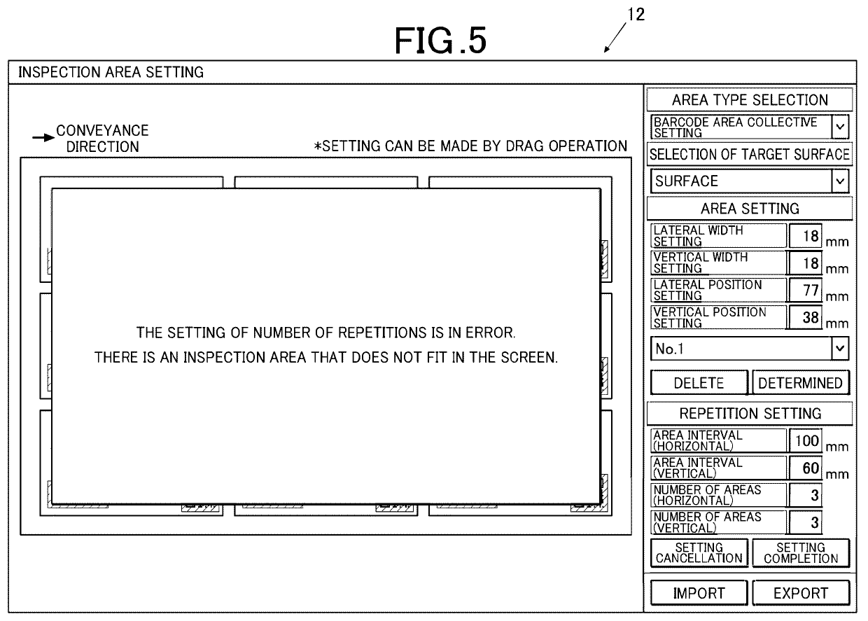

For example, as the predetermined control, the controller 16 sets the setting of the number of repetitions to an error and causes the display part 12 to display a warning. In the example illustrated in FIG. 5, a message “The setting of number of repetitions is in error. There is an inspection area that does not fit in the screen.” is displayed.

Furthermore, as the predetermined control, the controller 16 corrects the number of repetitions to the maximum number of repetitions that does not exceed the range of the reference image.

For example, in the example illustrated in FIG. 4, when the number of repetitions is set to “4”, the fourth inspection area is located outside the range of the reference image. Therefore, the controller 16 causes the display part 12 to display a warning or corrects the value of the number of repetitions to “3”.

The controller 16 compares the acquired read image with the reference image to inspect the presence or absence of abnormality. When inspecting the image printed in the inspection area (variable area), the controller 16 compares each of the plurality of inspection areas set for the reference image with an area corresponding to each inspection area of the read image. When a barcode or a number is printed in the inspection area, the controller 16 inspects whether or not the barcode or the number is printed in a format intended by the user. The format intended by the user is, for example, a format of sequential (first, second, and third---) arrangement. Even when the barcode is printed, the controller 16 inspects whether or not the contents indicated by the barcode are in order as a result of the analysis.

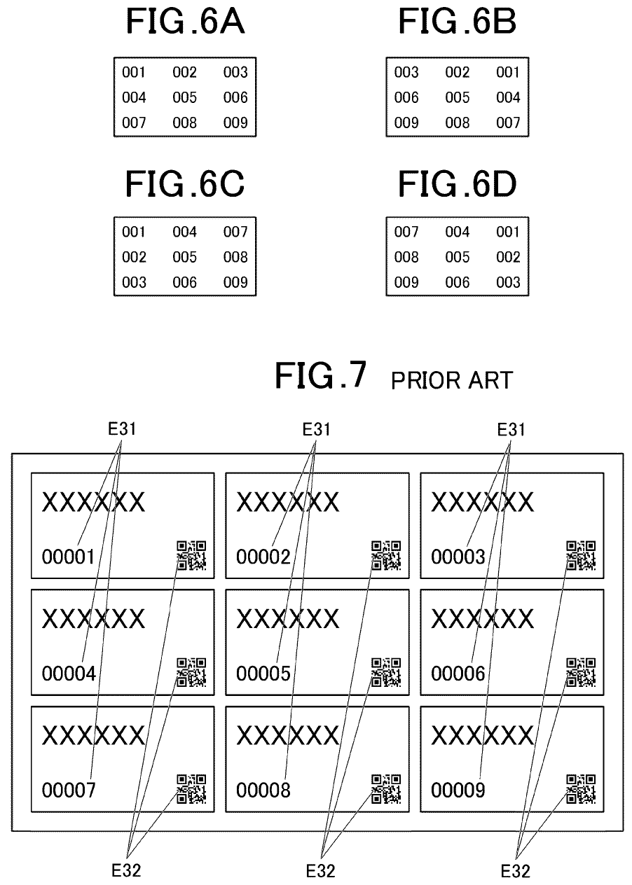

The operation part 11 is configured to be able to set the order in which the images to be printed in the plurality of inspection areas designated by the setting of the repetition condition are arranged. For example, as shown in FIG. 6A to FIG. 6D, the operation part 11 can set any one of the Z order of the upper left starting point (see FIG. 6A), the reverse Z order of the upper right starting point (see FIG. 6B), the reverse N order of the upper left starting point (see FIG. 6C), and the N order of the upper right starting point (see FIG. 6D). For example, in the example illustrated in FIG. 4, “Z order of upper left starting point” is set.

When inspecting the images printed in the inspection areas, the controller 16 first acquires the order in which the images to be printed in the plurality of inspection areas are arranged. Next, the controller 16 compares the read image with the reference image, and inspects whether or not the images printed in the inspection area are printed in the acquired order. Thus, the image printed in the inspection area can be inspected.

As described above, the image inspection system 1 according to the present embodiment includes a setter (the controller 16), a first acceptor (the controller 16), and a second acceptor (the controller 16). The setter sets a plurality of inspection areas in a reference image. The first acceptance section accepts designation of a first inspection area to be a reference among the plurality of inspection areas by a first designation method. The second acceptance section accepts designation of a second inspection area by a second designation method different from the first designation method. The second inspection area is an inspection area other than the first inspection area among the plurality of inspection areas. The setter sets the plurality of inspection areas based on the designation of the first inspection area accepted by the first acceptance section and the designation of the second inspection area accepted by the second acceptance section.

Therefore, according to the image inspection system 1 of the present embodiment, a plurality of inspection areas can be set by a simple setting operation. Therefore, it is possible to reduce time and effort for setting the inspection area (variable area).

Furthermore, the first designation method includes at least one of a method of designating an image to be inspected with respect to the reference image, a method of surrounding a predetermined area in the reference image, and a method of designating coordinates of a predetermined area in the reference image.

Therefore, the first inspection area serving as a reference can be set by a simple setting operation. Therefore, it is possible to reduce time and effort for setting the inspection area.

The second designation method includes a method of setting a repetition condition for a plurality of inspection areas. The repetition condition includes at least one of an interval between inspection areas and the number of repetitions of an inspection area.

Therefore, the inspection area other than the first inspection area can be set by a simple setting operation. Therefore, it is possible to reduce time and effort for setting the inspection area.

Further, a setting controller (controller 16) for controlling the setting of the number of repetitions of the inspection area is provided. When the number of repetitions is set, if the inspection area after the repetition exceeds the range of the reference image, the setting controller sets the number of repetitions as an error, and causes the display part 12 to display a warning.

Therefore, in a case where the setting of the number of repetitions is an error, it is possible to notify the setter that the setting is an error. Therefore, the setting of the number of repetitions can be quickly corrected.

In a case where the number of repetitions is set and the inspection area after repetition exceeds the range of the reference image, the setting controller corrects the number of repetitions to the maximum number of repetitions within the range of the reference image.

Therefore, in a case where the setting of the number of repetitions is an error, it is possible to automatically correct the setting. Therefore, it is possible to appropriately set the number of repetitions without taking time and effort.

There is provided an operation part 11 capable of setting the order in which the images to be printed in the plurality of inspection areas designated by the setting of the repetition condition are arranged.

Therefore, when the image printed in the inspection area is inspected, the arrangement order of the images set by the operation part 11 can be acquired. Therefore, it is possible to inspect whether or not printing is performed in the acquired order. Thus, the image printed in the inspection area can be appropriately inspected.

Although the present invention has been specifically described above based on the embodiments, the present invention is not limited to the above-described embodiments, and can be modified without departing from the spirit and scope thereof.

For example, in the above-described embodiment, a plurality of inspection areas are set via the operation part 11 of the image forming apparatus 10, but the present invention is not limited thereto. For example, the plurality of inspection areas may be set via an operation part of a PC communicable with the image inspection system 1.

In the above-described embodiment, the image inspection system 1 is described as an example of a configuration for implementing the present invention, but the present invention is not limited thereto. For example, the present invention can be implemented by an apparatus (inspection area setting apparatus) alone which includes an image reading section, an operation part, and a controller. In this case, the controller functions as the acquisition section, the image inspection section, the setter, the first acceptance section, and the second acceptance section of the present invention.

Besides, the detailed configuration of each device and the detailed operation of each device constituting the image inspection system can also be appropriately modified without departing from the spirit and scope of the present invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image inspection system comprising a hardware processor that:
acquires a read image obtained by reading an image on a sheet with an image reader;
compares the acquired read image with a reference image to inspect whether there is an abnormality;
sets a plurality of inspection areas with respect to the reference image;
accepts designation of a first inspection area serving as a reference among the plurality of inspection areas by a first designation method; and
accepts designation of a second inspection area, which is an inspection area other than the first inspection area among the plurality of inspection areas, by a second designation method different from the first designation method, wherein
the hardware processor sets the plurality of inspection areas based on the accepted designation of the first inspection area and the accepted designation of the second inspection area.

2. The image inspection system according to claim 1, wherein the first designation method includes at least one of a method of designating an image to be inspected with respect to the reference image, a method of surrounding a predetermined area in the reference image, and a method of designating coordinates of a predetermined area in the reference image.

3. The image inspection system according to claim 1, wherein the second designation method includes a method of setting a repetition condition for the plurality of inspection areas.

4. The image inspection system according to claim 3, wherein the repetition condition includes at least one of an interval between the inspection areas and a number of repetition of the inspection areas.

5. The image inspection system according to claim 4, wherein the hardware processor controls setting of the number of the repetition of the inspection areas.

6. The image inspection system according to claim 5, wherein in a case where the inspection areas after the repetition exceed a range of the reference image when the number of the repetition is set, the hardware processor determines the setting of the number of the repetition as an error, and causes a display to display a warning.

7. The image inspection system according to claim 5, wherein in a case where the inspection areas after the repetition exceed a range of the reference image when the number of the repetition is set, the hardware processor corrects the number of the repetition to a maximum number of repetition within the range of the reference image.

8. The image inspection system according to claim 4, further comprising an operation receiver capable of setting an order in which images to be printed are arranged in the plurality of inspection areas designated by setting the repetition condition.

9. An inspection area setting apparatus comprising a hardware processor that:
acquires a read image obtained by reading an image on a sheet with an image reader;
compares the acquired read image with a reference image to inspect whether there is an abnormality;
sets a plurality of inspection areas with respect to the reference image;
accepts designation of a first inspection area serving as a reference among the plurality of inspection areas by a first designation method; and
accepts designation of a second inspection area, which is an inspection area other than the first inspection area among the plurality of inspection areas, by a second designation method different from the first designation method, wherein
the hardware processor sets the plurality of inspection areas based on the accepted designation of the first inspection area and the accepted designation of the second inspection area.

10. A non-transitory computer-readable recording medium storing a program for a computer of an image inspection system including a hardware processor that: acquires a read image obtained by reading an image on a sheet with an image reader; and compares the acquired read image with a reference image to inspect whether there is an abnormality, the program causing the computer to perform:
setting a plurality of inspection areas with respect to the reference image;
accepting designation of a first inspection area serving as a reference among the plurality of inspection areas by a first designation method; and
accepting designation of a second inspection area, which is an inspection area other than the first inspection area among the plurality of inspection areas, by a second designation method different from the first designation method, wherein
the computer sets the plurality of inspection areas based on the accepted designation of the first inspection area and the accepted designation of the second inspection area.
